(19) United States
(12) Patent Application Publication
(10) Pub. No.: US 2007/0242323 A1
(43) Pub. Date: Oct. 18, 2007

(54) Holographic recording composition and optical recording medium therewith

(75) Inventor: Satoru Yamada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,926

(22) Filed: Mar. 29, 2007

(30) Foreign Application Priority Data
Mar. 31, 2006 (JP) 2006-098980

(51) Int. Cl. G03H 1/02

(52) U.S. Cl. 359/3

(57) ABSTRACT

Provided is a holographic recording composition comprising an imine compound having a pKa of 11 or more in water at 25° C., and, an acidic compound having a pKa of below 11 in water at 25° C. Preferably, the imine compound having a pKa of 11 or more in water at 25° C. is expressed by General Formula (1) below: 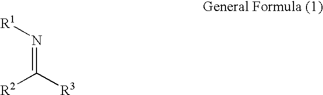
in the General Formula (1), R¹, R² and R³, which may be identical or different each other, each represents an alkyl group, an aryl group, an amino group or an acyl group; the alkyl group, the aryl group, the amino group or the acyl group may further have a substituent.

### BACKGROUND OF THE INVENTION

1. Field of the Invention

The present invention relates to holographic recording compositions, suited for producing therefrom volume holographic optical recording media with larger recording-layer thicknesses in particular, to which information can be recorded and reproduced by use of laser light, and also optical recording media that utilize the holographic recording compositions.

2. Description of the Related Art

Holographic optical recording media have been heretofore developed on the basis of holography. Information can be recorded onto the holographic optical recording media by way of overlapping lights having image information and reference lights in recording layers formed of photosensitive compositions, and writing the resulting interference stripes onto recording layers. On the other hand, information lights are reproduced by way of irradiating reference lights onto recording layers at certain angles and causing optical diffraction of the reference lights by action of the interference stripes.

Volume holography, in particular digital volume holography, has recently been developed in feasible regions and has been attracting attention with respect to the possibility of ultra high-density optical recording. In the volume holography, the optical recording media are utilized aggressively in their thickness direction as well and the interference stripes are three-dimensionally written, providing features that larger thicknesses lead to higher diffraction efficiencies and larger recording capacities by use of multiple recording. In the digital volume holography, the recording is carried out in the similar recording media/manners as volume holography except that the recording image information is exclusively binarized into digital patterns so as to adapt to computers. In the digital volume holography, for example, analog image information such as pictures is once digitized to represent as two-dimension digital pattern information, which is recorded as image information. Upon reproduction, the digital pattern information is read and decoded, thereby to express the original image information. These processes may make possible to reproduce extremely faithfully the original information, even when S/N ratio (ratio of signal to noise) is somewhat lower by virtue of derivative detection and/or correcting errors through coding the binarized data (see Japanese Patent Application Laid-Open (TP-A) No. 11-311936).

These volume holographic optical recording media are expected to sufficiently exhibit higher sensitivity and multi-recording ability, thus to record and regenerate plane information with higher resolutions. From these viewpoint, a holographic recording composition is proposed that contains a matrix with a urethane bond (see JP-A No. 2005-502918), and also a holographic recording composition is proposed that contains a compound polymerizable through ring-opening (see Japanese Patent No. 2873126). However, the holographic recording compositions like those described in these literatures of the prior art lead to optical recording with lower sensitivity in general, thus still further improvement and/or development are demanded currently.

### BRIEF SUMMARY OF THE INVENTION

The present invention aims to solve the problems in the art and to attain the objects below. That is, the present invention purposes to provide a holographic recording composition that can lead to a highly sensitive holographic recording medium and an optical recording medium that contains the holographic recording composition.

The present inventors have investigated vigorously to solve the problems described above and have found that the holographic recording composition, which comprises an imine compound having a pKa of 11 or more in water at 25° C. and an acidic compound having a pKa of below 11 in water at 25° C., may lead to efficient production of highly sensitive optical recording media and thus to solve successfully the problems in the art.

The present invention has been made based on our findings described above, that is, the problems in the art may be solved by the present invention as follows:

The holographic recording composition according to the present invention comprises an imine compound having a pKa of 11 or more in water at 25° C. and an acidic compound having a pKa of below 11 in water at 25° C.

The optical recording medium according to the present invention comprises a holographic recording layer that is formed from a holographic recording composition comprising an imine compound having a pKa of 11 or more in water at 25° C. and an acidic compound having a pKa of below 11 in water at 25° C.

The optical recording medium according to the present invention may bring about a novel optical recording method, in which the method comprises irradiating an informing light and a reference light, which being coherent each other, onto the inventive optical recording medium, forming an interference image from the informing light and the reference light, and recording the interference image on a holographic recording layer of the optical recording medium; in which the holographic recording layer is formed from a holographic recording composition that comprises an imine compound having a pKa of 11 or more in water at 25° C. and an acidic compound having a pKa of below 11 in water at 25° C.

Preferably, the informing light and the reference light are irradiated onto the optical recording medium in a manner that the optical axis of the informing light is coaxial with the optical axis of the reference light, then the interference image generated by the interference between the informing light and the reference light is recorded onto the holographic recording layer of the optical recording medium.

In addition, the optical recording medium according to the present invention may bring about a novel optical regenerating method, in which information is recorded by way of irradiating an informing light and a reference light, which being coherent each other, onto an optical recording medium, forming an interference image from the informing light and the reference light, and recording the interference image on a holographic recording layer of the optical recording medium; then the information is reproduced by way of irradiating the reference light onto interference patterns; in which, the holographic recording layer is formed from a holographic recording composition that comprises an imine compound having a pKa of 11 or more in water at 25° C. and an acidic compound having a pKa of below 11 in water at 25° C.

In addition, the optical recording medium according to the present invention may bring about a novel optical recording/regenerating apparatus, in which the information is recorded on the inventive optical recording media having a holographic recording layer by way of irradiating an informing light and a reference light and then the information is regenerated by way of irradiating the reference light; the holographic recording layer is formed from a holographic recording composition that comprises an imine compound having a pKa of 11 or more in water at 25° C. and an acidic compound having a pKa of below 11 in water at 25° C.

The present invention may solve various problems in the art, that is, may provide a holographic recording composition, which can lead to a highly sensitive holographic recording medium, and also an optical recording medium that contains the holographic recording composition.

### BRIEF DESCRIPTION OF THE SEVERAL VIEWS OF THE DRAWINGS

FIG. 1 is a schematic cross section that exemplarily shows an optical recording medium of the first embodiment according to the present invention.

FIG. 2 is a schematic cross section that exemplarily shows an optical recording medium of the second embodiment according to the present invention.

FIG. 3 is an exemplary view that explains an optical system around the inventive optical recording medium.

FIG. 4 is a block diagram that shows exemplarily an entire construction of an optical recording/reproducing apparatus equipped with an optical recording medium according to the present invention.

### DETAILED DESCRIPTION OF THE INVENTION

Holographic Recording Composition

The holographic recording composition according to the present invention comprises an imine compound having a pKa of 11 or more in water at 25° C. and an acidic compound having a pKa of below 11 in water at 25° C., and also preferably a radical-polymerizable monomer, a photopolymerization initiator, a urethane matrix and other ingredients as required.

At least a portion of the imine compound having a pKa of 11 or more and at least a portion of the acidic compound having a pKa of below 11 may form a complex salt in the holographic recording composition.

Imine Compound with pKa of 11 or more The imine compound having a pKa of 11 or more may be properly selected, for example, from those expressed by the General Formula (1).

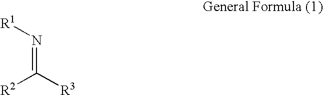

In the General Formula (1), R¹, R² and R³, which may be identical or 15 different each other, each represents an alkyl group, an aryl group, an amino group or an acyl group. The alkyl group, the aryl group, the amino group or the acyl group may further have a substituent.

It is preferred in the compounds expressed by the General Formula (1) that any two of R¹, R² and R³ bind each other to form at least a ring structure, more preferably, all of R¹, R² and R³ bind each other to form at least two ring structures.

In cases where any two of R¹, R² and R³ bind each other to form at least a ring structure, the carbon number of the compounds expressed by the General Formula (1) is preferably 7 to 20, more preferably 7 to 10, particularly preferably 7 to 9.

In cases where all of R¹, R² and R³ bind each other to form at least two ring structures, the carbon number of the compounds expressed by the General Formula (1) is preferably 7 to 20, more preferably 7 to 10, particularly preferably 7 to 9.

It is preferred in the compounds expressed by the General Formula (1) that R¹, R² and R³ are each an alkyl group or an amino group, among the alkyl, aryl, amino and acyl groups described above.

It is also preferred in the compounds expressed by the General Formula (1) that at least one of R¹, R² and R³ contains a nitrogen atom, more preferably, at least one of R² and R³ is an amino group, particularly preferably R¹ is an alkyl group and at least one of R² and R³ is an amino group.

The alkyl group may be properly selected depending on the application; preferably, the carbon number of the alkyl group is 1 to 20, more preferably 1 to 10, particularly preferably 1 to 5.

Specific examples of the alkyl group include methyl group, ethyl group, n-propyl group, isopropyl group, n-butyl group, isobutyl group, tert-butyl group, pentyl group, cyclopentyl group, hexyl group, cyclohexyl group, heptyl group, octyl group, tert-octyl group, 2-ethylhexyl group, decyl group, dodecyl group and octadecyl group.

The alkyl groups described above may further have a substituent; examples of the substituent include phenyl group, amino groups, halogen atoms, alkoxy groups, aryloxy groups, alkoxycarbonyl groups, acyloxy groups, acylamino groups, carbamoyl group, cyano group and heterocyclic groups. Among these, preferable are phenyl group and amino groups, particularly preferable are amino groups.

The aryl groups may be properly selected depending on the application; preferably, the carbon number of the alkyl groups is 6 to 20, more preferably 6 to 10, particularly preferably 6.

Specific examples of the aryl group include phenyl group, tolyl group, naphthyl group and anthranil group.

The aryl groups described above may further have a substituent; examples of the substituent include alkyl groups, phenyl group, amino groups, halogen atoms, alkoxy groups, aryloxy groups, alkoxycarbonyl groups, acyloxy groups, acylamino groups, carbamoyl group, cyano group and heterocyclic groups. Among these, preferable are alkyl groups.

It is preferred that the number of the substituent of the aryl group is preferably two or less, more preferably one in the General Formula (1).

The amino groups described above may be properly selected from non-substituted, mono-substituted or di-substituted groups; the substituent attached to the amino groups is preferably one selected from the alkyl and aryl groups described above.

Specific examples of the amino groups include methylamino group, ethylamino group, n-propylamino group, isopropylamino group, n-butylamino group, cyclohexylamino group, dimethylamino group, diethylamino group, di-n-propylamino group, diisopropylamino group, di-n-butylamino group and dicyclohexylamino group.

The acyl group described above may be properly selected depending on the application; the substituent attached to the acyl group is preferably one selected from the alkyl and aryl groups described above.

Specific examples of the acyl group are acetyl group, ethylcarbonyl group, n-propylcarbonyl group, isopropylcarbonyl group and phenylcarbonyl group.

Among these, preferable compounds expressed by the General Formula (1) are 1,8-diazabicyclo[5,4,0]unde-7-cene, 1,5-diazabicyclo[4,3,0]non-5-ene and 7-methyl-1,5,7-triazabicyclo[4,4,0]de-5-ene, more preferably 1,8-diazabicyclo[5,4,0]unde-7-cene.

Specific structures of the imine compounds having a pKa of 11 or more will be explained in the following, but to which in no way are limited the imine compounds that are incorporated into the holographic recording composition according to the present invention. These compounds may be used alone or in combination of two or more. 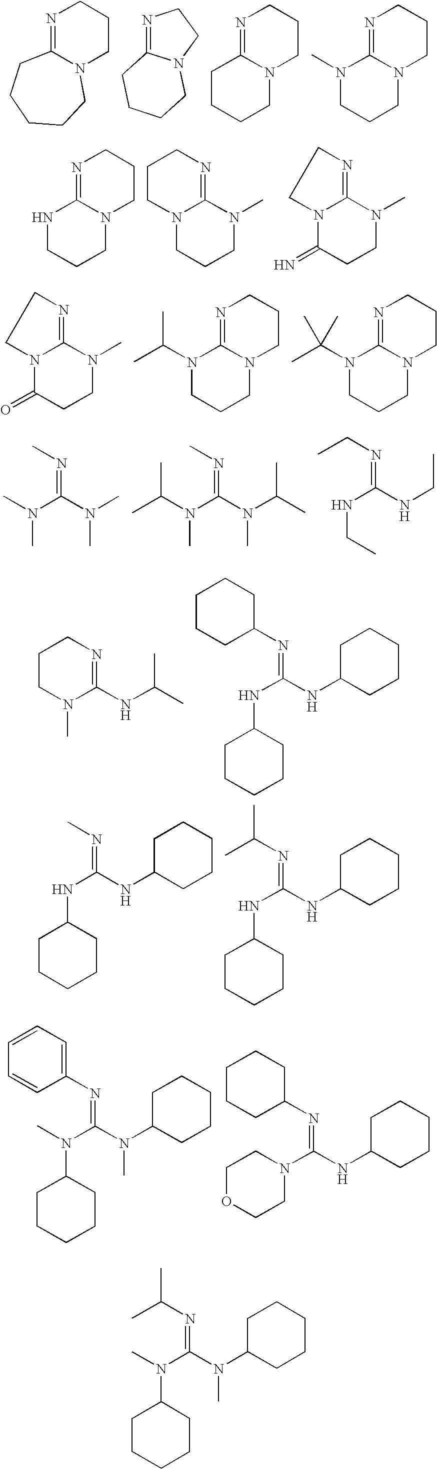 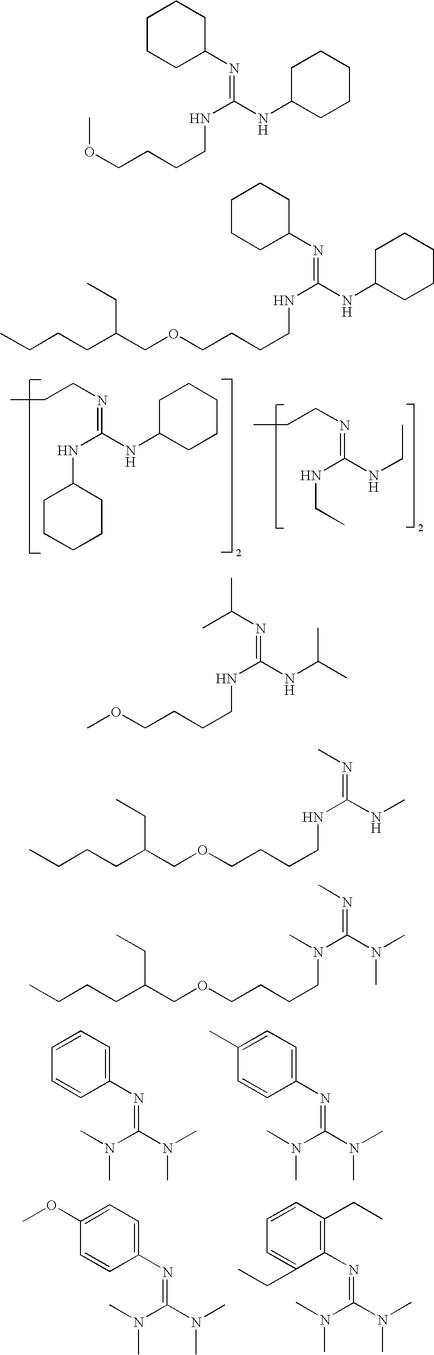 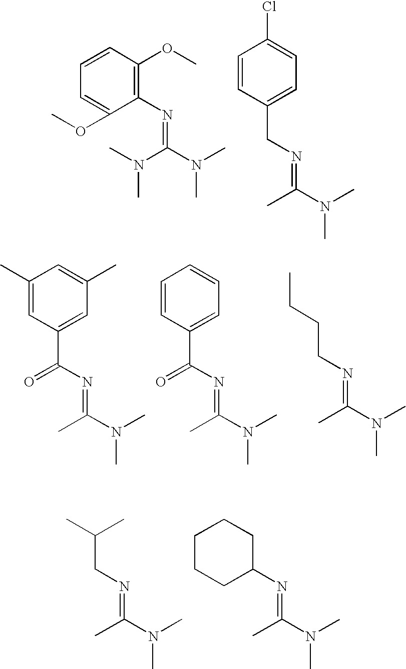
Acidic Compound With pKa of Below 11

The acidic compound having a pKa of below 11 may be properly selected depending on the application; it is preferred that the acidity degree of the acidic compound is sufficiently high enough to form a complex salt with the imine compound having a pKa of 11 or more.

The acidic compound having a pKa of below 11 may be exemplified by halogenated hydroacids, carboxylic acids, sulfonic acids and phenol derivatives.

The halogenated hydroacids may be properly selected depending on the application; specific examples thereof are hydrochloric acid, hydroiodic acid, etc.

The carboxylic acids described above may be properly selected depending on the application; preferably, the carbon number of the carboxylic acids is 1 to 12, more preferably 1 to 7, particularly preferably 1 to 6.

Specific examples of the carboxylic acids include acetic acid, trifluoroacetic acid, butyric acid, butanoic acid, hexanoic acid, octanoic acid, benzoic acid and 4-methylbenzoic acid.

The sulfonic acids described above may be properly selected depending on the application; preferably, the carbon number of the suffonic acid is 1 to 12, more preferably 1 to 7, particularly preferably 1 to 6.

Specific examples of the sulfonic acids include methanesulfonic acid, trifluoromethanesulfonic acid, ethanesulfonic acid, butanesulfonic acid, hexanesuffonic acid, benzenesulfonic acid and toluenesulfonic acid.

The phenol derivatives described above may be properly selected depending on the application; preferably, the carbon number of the phenol derivatives is 6 to 12, more preferably 6 to 10, particularly preferably 6 to 7.

Specific examples of the phenol derivatives include phenol, 4-methylphenol, 4-methoxyphenol, 3-chlorophenol and 1-hydroxynaphthalene.

The acidic compound having a pKa of below 11 may be fluoboric acid, hexafluorophosphoric acid and perchloric acid, in addition to the halogenated hydroacids, carboxylic acids, sulfonic acids and phenol derivatives described above.

Among these, the acidic compound having a pKa of below 11 is preferably acetic acid, trifluoroacetic acid, methanesulfonic acid, trifluoromethanesulfonic acid, toluenesulfonic acid and phenol, more preferably acetic acid, trifluoroacetic acid, methanesulfonic acid, trifluoromethanesulfonic acid and phenol, particularly preferably acetic acid and phenol.

Specific structures of the acidic compounds having a pKa of below 11 will be explained in the following, but to which in no way are limited the acidic compounds that are incorporated into the holographic recording composition according to the present invention. These compounds may be used alone or in combination of two or more.
Acidic Compounds With pKa of Below 11

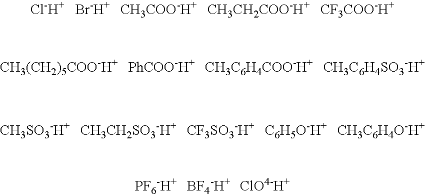

The mole ratio of the imine compound having a pKa of 11 or more to the acidic compound having a pKa of below 11 (mole number of imine compound/mole number of acidic compound) may be properly selected depending on the application; preferably the mole ratio is 100/1 to 1/1, more preferably 1, i.e. the mole numbers are substantially the same.

Complex Salt

The complex salt formed from the imine compound having a pKa of 11 or more and the acidic compound having a pKa of below 11 may be expressed by the General Formula (2).

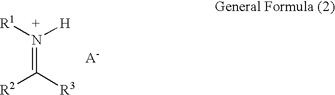

In the General Formula (2), R¹, R² and R³, which may be identical or different each other, each represents an alkyl group, an aryl group, an amino group or an acyl group. The alkyl group, the aryl group, the amino group or the acyl group may further have a substituent. The A⁻ indicates an anion species.

The anion species expressed by the A⁻ in the General Formula (2) may be properly selected depending on the application; examples thereof include halogen anions, carboxylate anions, sulfonate anions and aryloxy anions. Among these, carboxylate anions and aryloxy anions are preferable.

The halogen anions may be properly selected depending on the application; specific examples thereof are chlorine ion and iodine ion.

The carboxylate anions described above may be properly selected depending on the application; preferably, the carbon number of the carboxylate anion is 1 to 12, more preferably 1 to 7, particularly preferably 1 to 6.

Specific examples of the carboxylate anions include acetic acid anion, trifluoroacetic acid anion, butyric acid anion, butanoic acid anion, hexanoic acid anion, octanoic acid anion, benzoic acid anion and 4-methylbenzoic acid anion.

The sulfonate anions described above may be properly selected depending on the application; preferably, the carbon number of the sulfonate anion is 1 to 12, more preferably 1 to 7, particularly preferably 1 to 6.

Specific examples of the sulfonate anions include methanesulfonic acid anion, trifluoromethanesulfonic acid anion, ethanesulfonic acid anion, butanesulfonic acid anion, hexanesulfonic acid anion, benzenesulfonic acid anion and toluenesulfonic acid anion.

The aryloxy anions described above may be properly selected depending on the application; preferably, the carbon number of the sulfonate anion is 6 to 12, more preferably 6 to 10, particularly preferably 6 to 7.

Specific examples of the aryloxy anions include phenoxy anion, 4-methylphenyloxy anion, 4-methoxyphenyloxy anion, 3-chlorophenyloxy anion and 1-hydroxynaphthalene anion.

The anion species expressed by the A⁻ in the General Formula (2) may be tetrafluoroborate anion, hexafluorophosphate anion or perchloric acid anion, in addition to halogen anions, carboxylate anions, sulfonate anions and aryloxy anions.

Among these, the anion species expressed by the A⁻ in the General Formula (2) described above are preferably acetic acid anion, trifluoroacetic acid anion, methanesulfonic acid anion, trifluoromethanesulfonic acid anion, toluenesulfonic acid anion and phenoxy anion, more preferably acetic acid anion, trifluoroacetic acid anion, methanesulfonic acid anion, trifluoromethanesulfonic acid anion and phenoxy anion, particularly preferably acetic acid anion and phenoxy anion.

In cases where the imine compound having a pKa of 11 or more bears plural nitrogen atoms, the complex salt, formed from the imine compound having a pKa of 11 or more and the acidic compound having a pKa of below 11, typically has an additional proton H+ on any nitrogen atom.

Specific examples of the complex salts expressed by the General Formula (2) are shown below.

| 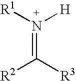 | A⁻ |
|---|---|
| 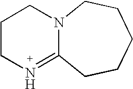 | CH₃COO⁻ |
| | CF₃COO⁻ |
| | CH₃(CH₂)₅COO⁻ |
| | PhCOO⁻ |
| | CH₃C₆H₄COO⁻ |
| | CH₃C₆H₄SO₃⁻ |
| | CH₃SO₃⁻ |
| | CF₃SO₃⁻ |
| | C₆H₅O⁻ |
| | CH₃C₆H₄O⁻ |
| 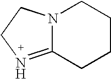 | CH₃COO⁻ |
| | CF₃COO⁻ |
| | CH₃(CH₂)₅COO⁻ |
| | PhCOO⁻ |
| | CH₃C₆H₄COO⁻ |
| | CH₃C₆H₄SO₃⁻ |
| | CH₃SO₃⁻ |
| | CF₃SO₃⁻ |
| | C₆H₅O⁻ |
| | CH₃C₆H₄O⁻ |
| 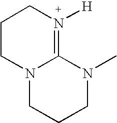 | CH₃COO⁻ |
| | CF₃COO⁻ |
| | PhCOO⁻ |
| | C₆H₅O⁻ |
| | CH₃C₆H₅O⁻ |

The content of the imine compound having a pKa of 11 or more and the acidic compound having a pKa of below 11 may be properly selected depending on the application; preferably, the content is 0.01 to 10% by mass on the basis of the total mass of the holographic recording composition, more preferably 0.01 to 2% by mass. In cases where the content is less than 0.01% by mass or above 10% by mass, it may be difficult to produce optical recording media with higher sensitivity.

Analytical Method

The imine compound having a pKa of 11 or more and the acidic compound having a pKa of below 11 may be analyzed by way of extracting holographic recording layers of optical recording media, which contains a recording layer formed from a holographic recording composition according to the present invention in the holographic recording layer, using a solvent such as dioxane, then the eluent is analyzed by liquid chromatography (HPLC). Adding Process to Holographic Recording Composition

The imine compound having a pKa of 11 or more and the acidic compound having a pKa of below 11 may be separately added to the inventive holographic recording composition, alternatively an complex salt of the imine compound and the acidic compound is added to the composition; preferably, such complex salts thereof are added to the composition.

Radical-Polymerizable Monomer

The radical-polymerizable monomer described above refers to a compound that can play a role in information recording and undergo radical-polymerization by initial action of photopolymerization initiators.

The radical-polymerizable monomer may be properly selected depending on the application, and exemplified by monomers with a unsaturated bond such as of acryloyl, methacryloyl, styryl, allyl and vinyl groups. The radical-polymerizable monomer may be of monofunctional or polyfunctional.

Examples of the radical-polymerizable monomers include acryloyl morpholine, phenoxyethylacrylate, isobornylacrylate, 2-hydroxypropylacrylate, 2-ethylhexylacrylate, 1,6-hexanediol diacrylate, tripropyleneglycol diacrylate, neopentylglycol PO-modified diacrylate, 1,9-nonandiol diacrylate, hydroxylpivalic acid neopentylglycoldiacrylate, EO-modified bisphenol A diacrylate, polyethyleneglycol diacrylate, pentaerythritol triacrylate, pentaerythritol tetraacrylate, pentaerythritol hexaacrylate, EO-modified glycerol triacrylate, trimethylolpropane triacrylate, EO-modified trimethylolpropane triacrylate, 2-naphtho-1-oxyethylacrylate, 2-carbazoyl-9-ylethylacrylate, (trimethylsilyloxy)dimethylsilyl propylacrylate, vinyl-1-naphthoate, N-vinylcarbazol, 2,4-dibromophenylacrylate, 2,4,6-tribromophenylacrylate, pentabromoacrylate, phenylthioethylacrylate and tetrahydrofurfurylacrylate. Among these, particularly preferable are 2,4,6-tribromophenylacrylate, EO-modified bisphenol A diacrylate, 2,4-dibromophenylacrylate and N-vinylcarbazol. These may be used alone or in combination of two or more.

The content of the radical-polymerizable monomer in the holographic recording composition may be properly selected depending on the application; preferably, the content is 5 to 50% by mass, more preferably 5 to 20% by mass. In cases where the content is below 5% by mass, satisfactory reproducing images may be unobtainable, and in cases where the content is above 50% by mass, accurate reproducing images may be unobtainable due to inclusion of scattering light into reproducing light.

Photopolymerization Initiator

The photopolymerization initiator may be selected from those sensitive to recording lights, for example, from radical-photopolymerization initiators.

The radical-photopolymerization initiators may be properly selected from those sensitive to recording light such as those inducing radical polymerization upon irradiating light.

Examples of the radical-photopolymerization initiator include 2,2′-bis(o-chlorophenyl)4,4′,5,5′-tetraphenyl-1,1′-biimidazole, 2,4,6-tris(trichloromethyl)-1,3,5-triazine, 2,4-bis(trichloromethyl)-6-(p-methoxyphenylvinyl)-1,3,5-triazine, diphenyliodoniumtetrafluoroborate, diphenyliodoniumhexafluorophosphate, 4,4′-di-t-butyldiphenyliodoniumtetrafluoroborate, 4-diethylaminophenylbenzenediazonium hexafluorophosphate, benzoin, 2-hydroxy-2-methyl-1-phenylpropane-2-one, benzophenone, thioxanthone, 2,4,6-trimethylbenzoyldiphenylacyl phosphineoxide, triphenylbutylborate tetraethylammonium, bis(η5-2,4-cyclopentadiene-1-yl)-bis[2,6-difluoro-3-(1H-pyrrole-1-yl)phenyltitanium], and diphenyl-4-phenylthiophenylsulfonium hexafluorophosphate. Among these, titanocene radical-photopolymerization initiators such as bis(η5-2,4-cyclopentadiene-1-yl)-bis[2,6-difluoro-3-(1H-pyrrole-1-yl)phenyltitanium] are most preferable. These may be used alone or in combination of two or more. The sensitizing dyes described later may also be added so as to adapt with irradiating wavelengths.

The content of the photopolymerization initiator in the holographic recording composition may be properly selected depending on the application; preferably, the content is 0.01 to 5% by mass based on total mass of the holographic recording composition, more preferably 1 to 3% by mass. The content of less than 0.01% by mass may lead to insufficient initial reaction and thus impossible recording, meanwhile the content of above 5% by mass may lead to significant errors of recording data since substantially no light reaches the bottom of recording media.

Urethane Matrix

The urethane matrix refers to polymers to hold or sustain monomers, available in recording and/or preservation, and photopolymerization initiators. The matrix is employed to improve film-coating property, to enhance film strength and/or to upgrade hologram recording properties.

The urethane matrix may be formed from polyfunctional isocyanates and polyfunctional alcohols and also other optional ingredients.

The urethane matrix may be linear or preferably three-dimensionally cross-linked ones; such a matrix may be formed by properly selecting radical-polymerizable monomers or the compatibility with the photopolymerization initiators.

Polyfunctional Isocyanate

The polyfunctional isocyanate may be of lower or higher molecular weight; preferably, the number of isocyanate groups is 2 to 5.

Examples of the polyfunctional isocyanate include biscyclohexyl methanediisocyanate, hexamethylene diisocyanate, phenylene-1,3-diisocyanate, phenylene-1,4-diisocyanate, 1-methoxyphenylene-2,4-diisocyanate, 1-methylphenylene-2,4-diisocyanate, 2,4-thrylenediisocyanate, 2,6-thrylenediisocyanate, 1,3-xylylenediisocyanate, 1,4-xylylenediisocyanate, biphenylene-4,4′-diisocyanate, 3,3′-dimethoxybiphenylene-4,4′-diisocyanate, 3,3′-dimethylbiphenylene-4,4′-diisocyanate, diphenylmethane-2,4′-diisocyanate, diphenylmethane-4,4′-diisocyanate, 3,3′-dimethoxydiphenylmethane-4,4′-diisocyanate, 3,3′-dimethyldiphenylmethane-4,4′-diisocyanate, naphthylene-1,5-diisocyanate, cyclobutylene-1,3-diisocyanate, cyclopentylene-1,3-diisocyanate, cyclohexylene-1,3-diisocyanate, cyclohexylene-1,4-diisocyanate, 1-methylcyclohexylene-2,4-diisocyanate, 1-methylcyclohexylene-2,6-diisocyanate, 1-isocyanate-3,3,5-trimethyl-5-isocyanatemethylcyclohexane, cyclohexane-1,3-bis(methylisocyanate), cyclohexane-1,4-bis(methylisocyanate), isophoronediisocyanate, dicyclohexylmethane-2,4′-diisocyanate, dicyclohexylmethane-4,4′-diisocyanate, ethylenediisocyanate, tetramethylene-1,4-diisocyanate, hexamethylene-1,6-diisocyanate, dodecamethylene-1,12-diisocyanate, phenyl-1,3,5-triisocyanate, diphenylmethane-2,4,4′-triisocyanate, diphenylmethane-2,5,4′-triisocyanate, triphenylmethane-2,4′,4″-triisocyanate, triphenylmethane-4,4′,4″-triisocyanate, diphenylmethane-2,4,2′,4′-tetraisocyanate, diphenylmethane-2,5,2′,5′-tetraisocyanate, cyclohexane-1,3,5-triisocyanate, cyclohexane-1,3,5-tris(methylisocyanate), 3,5-dimethylcyclohexane-1,3,5-tris(methylisocyanate), 1,3,5-trimethylcyclohexane-1,3,5-tris(methylisocyanate), dicyclohexylmethane-2,4,2′-triisocyanate, dicyclohexylmethane-2,4,4′-triisocyanatelysine diisocyanatemethylester, and also prepolymers having isocyanates at both ends that are prepared by reaction between these organic isocyanate compounds of over stoichiometric quantities and polyfunctional compounds containing an active hydrogen. Among these, biscyclohexyl methanediisocyanate and hexamethylene diisocyanate are preferable in particular. These may be used alone or in combination of two or more.

Polyfunctional Alcohol

The polyfunctional alcohol may be properly selected depending on the application, and may be of lower or higher molecular weight.

Examples of the polyfunctional alcohols include glycols such as ethylene glycol, diethylene glycol, triethylene glycol, polyethylene glycol, propylene glycol, polypropylene glycol and neopentyl glycol; diols such as butanediol, pentanediol, hexanediol, heptanediol and tetramethylene glycol; triols such as glycerin, trimethylolpropane, butanetriol, pentanetriol, hexanetriol, decanetriol and polypropyleneoxide triol; polyphenols such as catechol and resorcinol; bisphenols; and also these polyfunctional compounds modified with polyethyleneoxy chains. Among these, tetramethylene glycol, polypropyleneoxide triol and trimethylolpropane are preferable in particular. These may be used alone or in combination of two or more.

In the urethane matrix described above, the mass ratio of the polyfunctional isocyanate (A) and the polyfunctional alcohol (B) i.e. (A:B) is preferably 20 to 80:20 to 80, more preferably 40 to 60:40 to 70. The mass ratios outside this range described above may bring about insufficient curing of the matrix.

The content of the urethane matrix in the holographic recording composition may be properly selected depending on the application; preferably, the content is 10 to 95% by mass based on the entire mass of the holographic recording composition, more preferably 35 to 90% by mass. The content of below 10% by mass may render difficult to generate stable interference images, and in cases of above 95% by mass, desirable quality may be unavailable in view of diffraction efficiency.

Other Ingredients

The other ingredients may be curing catalysts, sensitizing dyes, polymerization inhibitors, antioxidants and photothermal conversion materials, for example, and also other ingredients as required.

Curing Catalyst

The holographic recording composition may contain curing catalysts in order to promote curing of the urethane matrix.

The curing catalyst may be properly selected, depending on the application as long as capable of promoting the curing, from those described in “SOLID POLYURETHANE ELASTOMERS, New York, Gordon and Breach Science Publishers, pp. 13-39, 1969”, for example.

The content of the curing catalyst in the holographic recording composition may be properly selected as long as capable of forming the urethane matrix; preferably, the content is 0.01 to 10% by mass based on the total mass of the urethane matrix, more preferably 0.01 to 5% by mass, particularly preferably 0.1 to 1% by mass.

Sensitizing Dye

The holographic recording composition may be added with sensitizing dyes as required. The sensitizing dyes may be conventional compounds described in “Research Disclosure, vol. 200, Dec. 1980, Item 20036” or “Sensitizer, pp. 160-163, Kodansha Ltd., ed. Katsumi Tokumaru and Shin Ohgawara, 1987.”, for example.

Specific examples of the sensitizing dyes are 3-ketocoumarin compounds described in JP-A No. 58-15603; thiopyrylium salts described in JP-A No. 58-40302; naphthothiazole merocyanine compounds described in Japanese Patent Application Publication (JP-B) Nos. 59-28328 and 60-53300; and merocyanine compounds described in JPB Nos. 61-9621 and 62-3842, JP-A Nos. 59-89303 and 60-60104.

Furthermore, the sensitizing dyes may be the dyes described in “Functional Dye Chemistry, 1981, CMC Publishing Co., pp. 393-416” or “Color Material, 60 (4), 212-224 (1987)”; more specific are cationic methine dyes, cationic carbonium dyes, cationic quinonimine dyes, cationic indoline dyes and cationic styryl dyes.

Still furthermore, the sensitizing dyes may keto dyes such as coumarin dyes including ketocoumarin and sulfocoumarin, merostyryl dyes, oxonol dyes and hemioxonol dyes; non-keto dyes such as non-keto polymethine dyes, triarylmethane dyes, xanthen dyes, anthracene dyes, rhodamine dyes, acridine dyes, aniline dyes and azo dyes; non-keto polymethine dyes such as azomethine dyes, cyanine dyes, carbocyanine dyes, dicarbocyanine dyes, tricarbocyanine dyes, hemicyanine dyes and styryl dyes; and quinonimine dyes such as azine dyes, oxazin dyes, thiazin dyes, quinoline dyes and thiazole dyes. The sensitizing dyes may be used alone or in combination of two or more.

The content of the sensitizing dye in the holographic recording composition may be properly selected depending on the application; preferably, the content is 0.001 to 5% by mass based on the total mass of the holographic recording composition, more preferably 0.1 to 2% by mass. The content of less than 0.001% by mass may not initiate efficient reaction, meanwhile the content of above 5% by mass may lead to significant errors of recording data since substantially no light reaches the bottom of recording media.

Polymerization Inhibitor and Antioxidant

Polymerization inhibitors and/or antioxidants may be added to the holographic recording composition in order to improve the storage stability of the recording composition.

Examples of such polymerization inhibitors and antioxidants include hydroquinones, p-benzoquinone, hydroquinone monomethylether, 2,6-di-tert-butyl-p-cresol, 2,2′-methylenebis(4-methyl-6-tert-butylphenol), triphenyl phosphite, trisnonylphenyl phosphite, phenothiazine, and N-isopropyl-N′-phenyl-p-phenylenediamine.

The content of the polymerization inhibitors or antioxidants in the holographic recording composition may be properly selected depending on the application; preferably, the content is no more than 3% by mass based on the total mass of the radical-polymerizable monomer. The content of more than 3% by mass may retard or even disturb the polymerization.

Photothermal Conversion Material

The holographic recording compositions may be added with photothermal conversion materials so as to enhance the sensitivity of holographic recording layers formed from the holographic recording compositions.

The photothermal conversion materials may be properly selected depending on the intended performance or capability; the materials are preferably organic dyes from the viewpoint that the materials may be conveniently included into recording layers along with photopolymers and incident lights may be far from scattering; in addition, the materials are preferably infrared-ray absorbing dyes from the viewpoint that the recording lights may be far from absorption and/or scattering.

The infrared-ray absorbing dyes may be properly selected depending on the application; preferably, the dyes are cationic dyes, complex-salt forming dyes or quinone neutral dyes. The maximum absorption wavelength of the infrared-ray absorbing dyes is preferably 600 nm to 1000 nm, particularly preferable is 700 nm to 900 nm.

The content of the infrared-ray absorbing dyes in the holographic recording composition may be determined depending on the maximum absorbance at infrared region of the resulting recording materials; preferably the absorbance is 0.1 to 2.5, more preferably 0.2 to 2.0.

The content of the infrared-ray absorbing dye in the holographic recording composition may be properly selected depending on the application; preferably, the content is 0.001 to 5% by mass based on the total mass of the holographic recording composition, more preferably 0.1 to 2% by mass. The content of less than 0.001% by mass may lead to insufficient heat generation, and the content of above 5% by mass may cause voids or strains in recording media due to excessive heat generation.

Furthermore, in order to mitigate the volume change at polymerization, the holographic recording compositions may be added with an ingredient that can diffuse into the inverse direction with that of polymerizable ingredients, or compounds having an acid cleavage configuration may be added in addition to the polymers as required.

The holographic recording composition according to the present invention may be variously applied for recording information through irradiating lights that involve the information, particularly preferably is utilized as a volume holographic recording composition.

In cases where the holographic recording composition is of lower viscosity below a level, recording layers may be made from the composition by casting processes; on the other hand, when the viscosity is excessively higher for the casting processes, the holographic recording composition is laid on a second substrate, then an first substrate is pressed onto the holographic recording composition similarly as lidding the first substrate onto the holographic recording composition to spread entirely a recording layer, thereby to form a recording medium.

Optical Recording Medium

The recording medium according to the present invention comprises a three-dimensional recording layer such as laminate recording layers on the basis of two-photon absorption and holographic recording layers on the basis of light interference. The optical recording media will be explained more specifically with respect to holographic recording in the following.

The inventive optical recording medium comprises a holographic recording layer formed from the inventive holographic recording composition, and also preferably comprises a first substrate, filter layer, holographic recording layer, second substrate, and also a reflective film, first gap layer, second gap layer and other layers as required.

The optical recording medium described above may be properly selected as long as capable of recording and reproducing on the basis of hologram, for example, may be of relatively thin plane holograms to record two-dimensional information or volume holograms to record numerous information such as stereo images, alternatively of transmissive or reflective type. The recording mode of the hologram may be, for example, of amplitude hologram, phase hologram, brazed hologram or complex amplitude hologram. Among these, so-called Collinear system is preferable in particular in which an informing light and a reference light are irradiated as a coaxial light beam, and information is recorded on the recording region by an interference pattern generated by the interference between the informing light and the reference light.

First and Second Substrates

The substrate may be properly selected depending on the application as for the shape, configuration, size etc.; the shape may be disc-like, card-like etc.; the material is required for the mechanical strength in terms of the hologram recording media. In the case that the light for recording or reproducing is directed through the substrate, it is necessary that the substrate is sufficiently transparent at the wavelength region of the employed light.

The material of the substrate is usually selected from glasses, ceramics, resins etc.; preferably, resins are employed in particular from the view point of formability and cost.

Examples of the resins include polycarbonate resins, acrylic resins, epoxy resins, polystyrene resins, acrylonitrile-styrene copolymers, polyethylene resins, polypropylene resins, silicone resins, fluorine resins, ABS resins and urethane resins. Among these, polycarbonate resins and acrylic resins are most preferable in view of their formability, optical characteristics and costs. The substrate may be properly prepared or commercially available.

Plural address-servo areas, i.e. addressing areas linearly extending in the radial direction of the substrate, are provided on the substrate at a given angle to one another, and each sector-form area between adjacent address-servo areas serves as a data area. In the address-servo areas, information for a focus servo operation and a tracking servo operation by means of a sampled servo system and address information are previously recorded (or pre-formatted) in the form of emboss pits (servo pits). The focus servo operation can be performed using a reflective surface of the reflective film. For example, wobble pits may be used as the information for tracking servo. The servo pit pattern is not necessarily required in the case that the optical recording medium is card-like shape.

The thickness of the substrate may be properly selected depending on the application; the thickness is preferably 0.1 to 5 mm, more preferably 0.3 to 2 mm. When the thickness of the substrate is less than 0.1 mm, the optical disc may be deformed during its storage; and when the thickness is more than 5 mm, the weight of the optical disc may be as heavy as over-loading on the drive motor.

Holographic Recording Layer

Information can be recorded onto the holographic recording layer, which being formed from the holographic recording composition, by use of holography.

The thickness of the holographic recording layer may be properly selected depending on the application; the thickness is preferably 1 to 1000 μm, more preferably 100 to 700 μm.

When the thickness of the holographic recording layer is within the preferable range, the sufficient S/N ratio may be attained even on the shift multiplex of 10 to 300; and the more preferable range may advantageously lead to more significant effect thereof.

Filter Layer

The filter layer is provided on the servo pit of the substrate, on the reflective layer, or on the first gap layer.

The filer layer performs wavelength-selective reflection in a manner that a light with a certain wavelength may be solely reflected among plural lights or beams, a first light is transmitted and the second light is reflected. The filter layer may perform in particular to prevent diffuse reflection of the informing light and the reference light from the reflective film of the optical recording medium and to prevent noise generation without the sift of selective reflection wavelength even if the incident angle being altered; therefore, the lamination of the filter layer with the optical recording medium may achieve optical recording with excellently high resolution and diffraction efficiency.

The filter layer may be properly selected depending on the application; for example, the filter layer may be formed of a laminated body containing a dichroic mirror layer, a color material-containing layer, a dielectric vapor deposition layer, a cholesteric layer of mono layer or two or more layers, and other layers properly selected as required.

The filter layer may be laminated directly to the substrate by way of coating etc. along with the holographic recording layer; alternatively, a filter for optical recording media is prepared by laminating on a base material such as films, then the filter layer may be laminated on the substrate.

Reflective Film

The reflective film is formed on the surface of the servo pit pattern of the substrate. As for the material of the reflective film, such material is preferable that provides the recording light and the reference light with high reflectivity. When the wavelength of light is 400 to 780 nm, Al, Al alloys, Ag, Ag alloys and the like are preferably used. When the wavelength of light is 650 nm or more, Al, Al alloys, Ag. Ag alloys, Au, Cu alloys, TiN and the like are preferably used.

By use of DVD (digital video disc), for example, as the optical recording medium capable of reflecting the light and also recording and erasing information, such directory information can be recorded and erased without adversely affecting holograms as those indicative of the locations where information being recorded, the time when the information being recorded, and the locations where errors being occurred and exchanged.

The process for forming the reflective film may be properly selected depending on the application; examples thereof include various types of vapor deposition, such as vacuum vapor deposition, sputtering, plasma CVD, photo CVD, ion plating, and electron beam vapor deposition. Among these, sputtering is most preferable in view of mass productivity, film quality, and the like. The thickness of the reflective film is preferably 50 nm or more, more preferably 100 nm or more, in order to secure sufficient reflectivity.

First Gap Layer

The first gap layer is provided between the filter layer and the reflective film as required for smoothing the surface of the substrate. Furthermore, the first gap layer is effective to adjust the size of the hologram formed in the holographic recording layer. Specifically, the gap layer between the holographic recording layer and the servo pit pattern may be effective, since the holographic recording layer requires the interference region of some larger size between the recording reference light and the informing light.

The first gap layer can be formed by, for example, applying UV curable resin etc. on the servo pit pattern by spin coating etc. and curing the resin. In addition, when the filter layer is formed on a transparent base material, the transparent base material also serves as the first gap layer. The thickness of the first gap layer may be properly selected depending on the application; the thickness is preferably 1 to 200 μm.

Second Gap Layer

The second gap layer may be provided between the holographic recording layer and the filter layer as required.

The material for the second gap layer may be properly selected depending on the application; examples thereof include transparent resin films such as triacetylcellulose (TAC), polycarbonate (PC), polyethylene terephthalate (PET), polystyrene (PS), polysulfone (PSF), polyvinylalcohol (PVA) and methyl polymethacrylate (PMMA); norbornene resin films such as ARTON (product name, by JSR Corp.), ZEONOA (product, by Nippon Zeon). In particular, those with higher isotropy are preferable, and TAC, PC, ARTON and ZEONOA are most preferable.

The thickness of the second gap layer may be properly selected depending on the application; the thickness is preferably 1 μm to 200 μm.

The optical recording media according to the present invention will be explained more specifically with reference to figures.

### First Embodiment

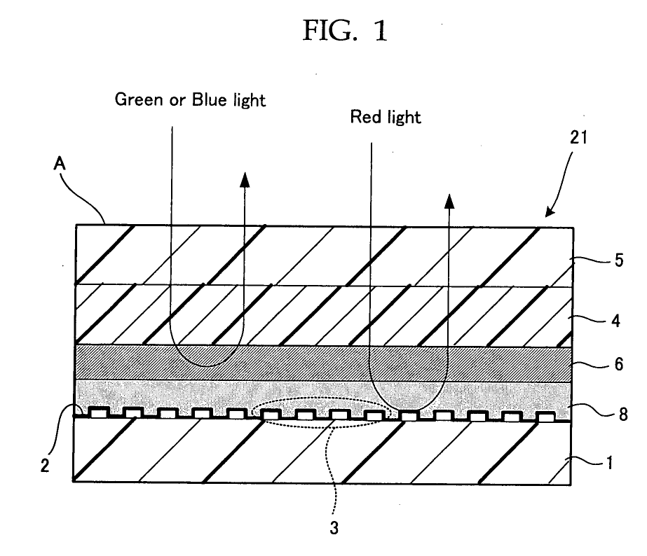

FIG. 1 is a schematic cross-sectional view showing the structure of the first embodiment of the optical recording medium in the present invention. In the optical recording medium 21 according to the first embodiment, servo pit pattern 3 is formed on the first substrate 1 made of a polycarbonate resin or glass, and the servo pit pattern 3 is coated with Al, Au, Pt or the like to form reflective film 2.

Here, the servo pit pattern 3 is formed on the entire surface of the first substrate 1 in FIG. 1, it may be formed periodically. The height of the servo pit pattern 3 is usually 1750 angstroms (175 nm), which being significantly smaller than the other layers including the substrate.

The first gap layer 8 is formed by applying UV curable resin or the like on the reflective film 2 of the first substrate 1 by spin coating or the like. The first gap layer 8 is effective for protecting the reflective film 2 and for adjusting the size of holograms created in recording layer 4. Specifically, the interference region between the recording reference light and the informing light requires a level of size in the holographic recording layer 4, the first gap layer 8 is effectively provided between the holographic recording layer 4 and the servo pit pattern 3.

The filter layer 6 is provided on the first gap layer 8, and the holographic recording layer 4 is sandwiched between the filter layer 6 and the second substrate 5 (polycarbonate resin or glass substrate) to thereby constitute the optical recording medium 21.

In FIG. 1, the filter layer 6 transmits only red light and blocks the other color lights. Since the informing light, recording light and reproducing reference light are of green or blue, they do not pass through the filter layer 6 instead turn into a return light to emit from the entrance/exit surface A without reaching the reflective film 2.

The filter layer 6 is a multilayer vapor-deposited film consisting of alternatively laminated higher refractive-index layers and lower refractive-index layers. The filter layer 6 of the multilayer vapor-deposited film may be formed directly onto the first gap layer 8 by vacuum vapor deposition, alternatively may be disposed by punching through the multilayer vapor-deposited film formed on the substrate into the shape of the optical recording medium.

The optical recording medium 21 of this embodiment may be of disc shape or card shape. The servo pit pattern is unnecessary in the case of card shape. In the optical recording medium 21, the first substrate 1 is 0.6 mm thick, the first gap layer 8 is 100 μm thick, the filter layer 6 is 2 μm to 3 μm thick, the holographic recording layer 4 is 0.6 mm thick, and the second substrate 5 is 0.6 mm thick, leading to the total thickness of about 1.9 mm.

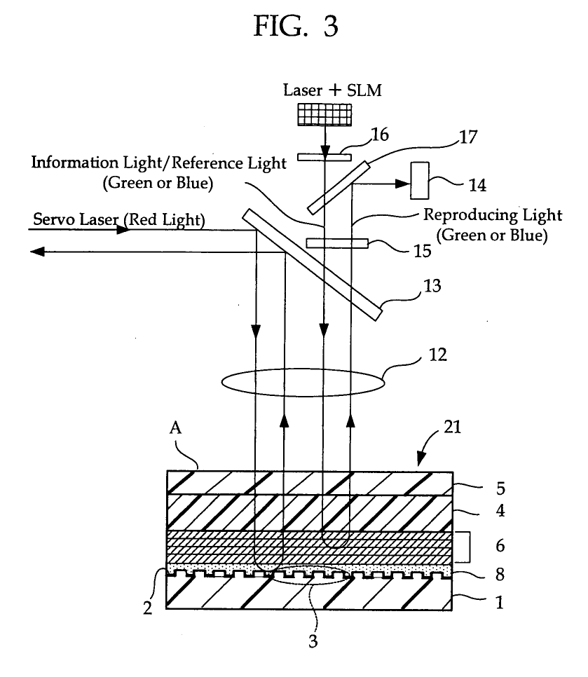

The optical operations around the optical recording medium 21 will be explained with reference to FIG. 3 in the following. Initially, red light emitted from the servo laser source is reflected at dichroic mirror 13 by almost 100%, and passes through objective lens 12. The servo light is applied onto the optical recording medium 21 in such a way that it focuses on the reflective film 2. More specifically, the dichroic mirror 13 is configured to transmit only green or blue light but reflect almost 100% of red light. The servo light incident from the light entrance/exit surface A of the optical recording medium 21 passes through the second substrate 5, holographic recording layer 4, filter layer 6 and first gap layer 8, then is reflected by the reflective film 2, and passes again through the first gap layer 8, filter layer 6, holographic recording layer 4 and second substrate 5 to emit from the light entrance/ exit surface A. The emitted return light passes through the objective lens 12 and is reflected by the dichroic mirror 13 by almost 100%, and then a servo information detector (not shown) detects servo information. The detected servo information is used for the focus servo operation, tracking servo operation, slide servo operation and the like. The hologram material constituting the holographic recording layer 4 is designed so as to be insensitive to red light, therefore, even when the servo light passes through the holographic recording layer 4 or reflects diffusively at the reflective film 2, the holographic recording layer 4 is not adversely affected. In addition, the return servo light reflected by the reflective film 2 is reflected almost 100% by the dichroic mirror 13, accordingly, the servo light is non-detectable by CMOS sensor or CCD 14 used for the detection of reconstructed images, thus providing the diffracted light with no noise.

Both of the informing light and the recording reference light emitted from the recording/reproducing laser source pass through the polarizing plate 16 to form a linear polarization then to form a circular polarization after passing through the half mirror 17 and the quarter wave plate 15. The circular polarization then passes through the dichroic mirror 13, and illuminates the optical recording medium 21 by action of the objective lens 12 in a manner that the informing light and the reference light create an interference pattern in the holographic recording layer 4. The informing light and reference light enter from the light entrance/exit surface A and interact with each other in the holographic recording layer 4 to form and record an interference pattern. Thereafter, the informing light and reference light pass through the holographic recording layer 4 and enter into the filter layer 6, and then, are reflected to turn into a return light before reaching the bottom of the filter layer 6. That is, the informing light and recording reference light do not reach the reflective film 2. This is because the filter layer 6, which being a multilayer vapor-deposited film consisting of alternatively laminated higher refractive-index layers and lower refractive-index layers, allows to exclusively transmit red light.

### Second Embodiment

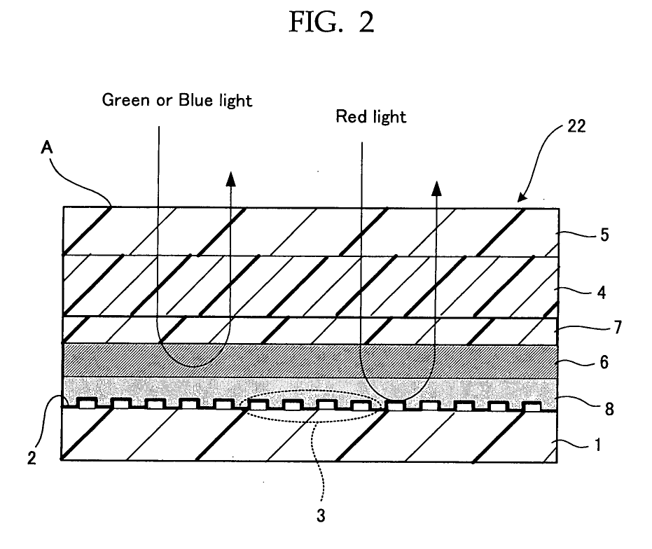

FIG. 2 is a schematic cross-sectional view showing the configuration of the second embodiment of the inventive optical recording medium. The optical recording medium 22 of the second embodiment is substantially the same as the first embodiment except that the second gap 7 is provided between the filter layer 6 and the holographic recording layer 4.

The second gap layer 7 involves a point at which the informing light and the reference light focus. Provided that this area is filled with a photopolymer, the monomer is likely to be excessively consumed by action of excessive exposure, resulting in decrease of multiple recording capacities. Accordingly, the nonreactive transparent second gap is effectively provided.

In the optical recording medium 22 of the second embodiment, the first substrate 1 is 1.0 mm thick, the first gap layer 8 is 100 μm thick, the filter layer 6 is from 3 μm to 5 μm thick, the second gap layer 7 is 70 μm thick, the holographic recording layer 4 is 0.6 mm thick, the second substrate 5 is 0.4 mm thick, and the total thickness is about 2.2 mm.

The optical recording medium 22 of the second embodiment may be of disc shape or card shape, and may be constructed similarly as the first embodiment.

The optical operations around the optical recording medium 22 of the second embodiment are similar as those of the optical recording medium 21 of the first embodiment.

Optical Recording Method and Optical Reproducing Method

The optical recording method in relation to the present invention comprises irradiating an informing light and a reference light having a coherent property onto the optical recording medium according to the present invention, forming an interference image from the informing light and the reference light, and recording the interference image onto the holographic recording layer of the optical recording medium.

In this method, the informing light and the reference light are irradiated onto the optical recording medium in a manner that the optical axis of the informing light is coaxial with the optical axis of the reference light, then the interference image generated by the interference between the informing light and the reference light is recorded onto the holographic recording layer of the optical recording medium.

In the optical reproducing method in relation to the present invention, a reproducing light is irradiated onto the interference pattern of the holographic recording layer which is recorded by the optical recording method according to the present invention.

In the optical recording method and the optical reproducing method according to the present invention, the informing light with a two-dimensional intensity distribution and the reference light with almost the same intensity to that of the informing light are superimposed inside the photosensitive recording layer, the resulting interference pattern formed inside the holographic recording layer induces a distribution of the optical properties of the holographic recording layer to thereby record such distribution as information. On the other hand, when the recorded information is to be read (reproduced), only the reference light (reproducing light) is irradiated onto the holographic recording layer from the same direction to that irradiated at the time of recording, a light having a intensity distribution corresponding to the distribution of the optical property formed inside the holographic recording layer is emitted from the holographic recording layer as a diffracted light.

The optical recording method and the optical reproducing method according to the present invention may be carried out by use of the optical recording/reproducing apparatus explained below.

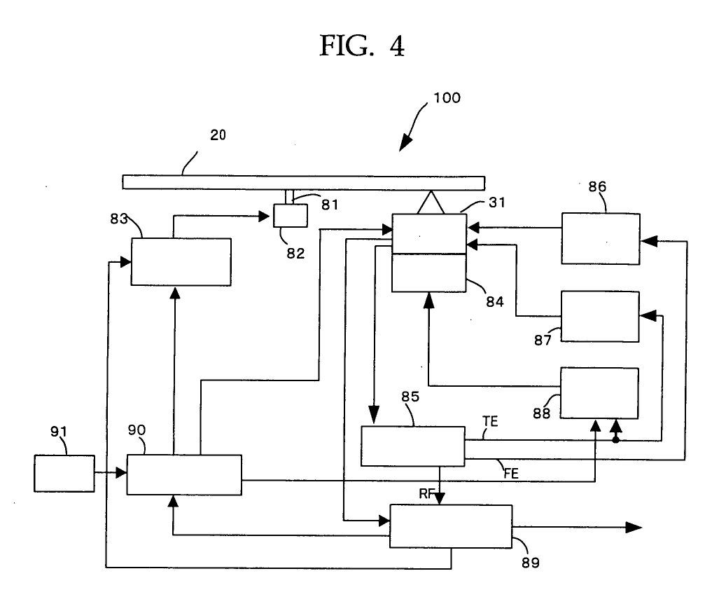

The optical recording/reproducing apparatuses applied to the optical recording method and the optical reproducing method in relation to the present invention will be explained with reference to FIG. 4.

This optical recording/reproducing apparatus 100 is equipped with spindle 81 on which the optical recording medium 20 is disposed, spindle motor 82 which rotates the spindle 81, and spindle servo circuit 83 which controls the spindle motor 82 so as to maintain the optical recording medium 20 at the predetermined revolution number.

The optical recording/reproducing apparatus 100 is also equipped with pickup unit 31 which irradiates the informing light and the reference light onto the optical recording medium 20 so as to record information, and irradiates the reproducing reference light onto the optical recording medium 20 so as to detect the diffracted light to thereby reproduce the information recorded at the optical recording medium 20, and driving unit 84 which enables the pickup unit 31 to move in the radius direction of optical recording medium 20.

The optical recording/reproducing apparatus 100 is equipped with detecting circuit 85 which detects focusing error signal FE, tracking error signal TE, and reproducing signal RF from the output signal of the pickup unit 31, focusing servo circuit 86 which drives an actuator in the pickup unit 31 so as to move an objective lens (not shown) to the thickness direction of the optical recording medium 20 based upon the focusing error signal FE detected by the detecting circuit 85 to thereby perform focusing servo, a tracking servo circuit 87 which drives an actuator in the pickup unit 31 so as to move an objective lens (not shown) to the thickness direction of the optical recording medium 20 based upon the tracking error signal TE detected by the detecting circuit 85 to thereby perform tracking servo, and a sliding servo circuit 88 which controls the driving unit 84 based upon the tracking error signal TE and an indication from a controller mentioned hereinafter so as to move the pickup unit 31 to the radius direction of the optical recording medium 20 to thereby perform sliding servo.

The optical recording/reproducing apparatus 100 is also equipped with signal processing circuit 89 which decodes output data of the CMOS or CCD array described below in the pickup unit 31, to thereby reproduce the data recorded in the data area of the optical recording medium 20, and to reproduce the standard clock or to determine the address based on the reproducing signal RF from the detecting circuit 85, controller 90 which controls the whole optical recording/reproducing apparatus 100, and controlling unit 91 which gives various instructions to the controller 90.

The controller 90 is configured to input the standard clock or address information outputted from the signal processing circuit 89 as well as controlling the pickup unit 31, the spindle servo circuit 83, the sliding servo circuit 88 and the like. The spindle servo circuit 83 is configured to input the standard clock outputted from the signal processing circuit 89. The controller 90 contains CPU (center processing unit), ROM (read only memory), and RAM (random access memory), the CPU realizes the function of the controller 90 by executing programs of the RAM as a working area stored in the ROM.

The optical recording/reproducing apparatuses, applied to the optical recording method and optical reproducing method described above, are equipped with the optical recording medium according to the present invention, thus can represent higher recording sensitivity and achieve high-density recording.

### EXAMPLES

The present invention will be explained with reference to Examples, but to which the present invention being in no way limited.

### Example 1

Preparation of Holographic Recording Composition

A mixture of an adduct, in an amount of 0.35 g, synthesized from equivalent mole of 1,8-diazabicyclo[5,4,0]unde-7-cene and acetic acid (pKa: 4.56 at 25° C.), 31.5 g of biscyclohexyl methanediisocyanate (by Tokyo Chemical Industry Co.), 61.2 g of polypropyleneoxide triol (molecular weight: 1000, by Aldrich Co.) and 2.5 g of tetramethylene glycol (by Aldrich Co.) was stirred at 25° C. for one hour to form a solution.

Then 3.1 g of 2,4,6-tribromophenylacrylate (by Dai-ichi Kogyo Seiyaku Co.), 0.69 g of a radical-photopolymerization initiator (Irgacure 784, by Ciba Specialty Chemicals Co.) and 1.01 g of dibutyltin dilaurate (by Wako Pure Chemical Industries, Ltd.) were added to the solution, and the mixture was stirred under nitrogen gas atmosphere to prepare a holographic recording composition.

### Example 2

Preparation of Holographic Recording Composition

A holographic recording composition was prepared in the same manner as Example 1 except that an adduct synthesized from equivalent mole of 1,8-diazabicyclo[5,4,0]unde-7-cene and phenol (pKa: 9.82 at 25° C.) was used in place of the adduct synthesized from equivalent mole of 1,8-diazabicyclo[5,4,0]unde-7-cene and acetic acid.

### Example 3

Preparation of Holographic Recording Composition

A holographic recording composition was prepared in the same manner as Example 1 except that an adduct synthesized from equivalent mole of 1,8-diazabicyclo[5,4,0]unde-7-cene and methanesulfonic acid (pKa: −2.6 at 25° C.) was used in place of the adduct synthesized from equivalent mole of 1,8-diazabicyclo[5,4,0]unde-7-cene and acetic acid.

### Example 4

Preparation of Holographic Recording Composition

A holographic recording composition was prepared in the same manner as Example 1 except that an adduct synthesized from equivalent mole of 1,5-diazabicyclo[4,3,0]non-5-ene and acetic acid was used in place of the adduct synthesized from equivalent mole of 1,8-diazabicyclo[5,4,0]unde-7-cene and acetic acid.

### Example 5

Preparation of Holographic Recording Composition

A holographic recording composition was prepared in the same manner as Example 1 except that an adduct synthesized from equivalent mole of 1,5-diazabicyclo[4,3,0]non-5-ene and phenol was used in place of the adduct synthesized from equivalent mole of 1,8-diazabicyclo[5,4,0]unde-7-cene and acetic acid.

### Example 6

Preparation of Holographic Recording Composition

A holographic recording composition was prepared in the same manner as Example 1 except that an adduct synthesized from equivalent mole of 7-methyl-1,5,7-triazabicyclo[4,4,0]de-5-ene and acetic acid was used in place of the adduct synthesized from equivalent mole of 1,8-diazabicyclo[5,4,0]unde-7-cene and acetic acid.

### Example 7

Preparation of Holographic Recording Composition

A holographic recording composition was prepared in the same manner as Example 1 except that an adduct synthesized from equivalent mole of 7-methyl-1,5,7-triazabicyclo[4,4,0]de-5-ene and phenol was used in place of the adduct synthesized from equivalent mole of 1,8-diazabicyclo[5,4,0]unde-7-cene and acetic acid.

### Example 8

Preparation of Holographic Recording Composition

A holographic recording composition was prepared in the same manner as Example 1 except that an adduct synthesized in a molar ratio of 1.1 moles of 1,8-diazabicyclo[5,4,0]unde-7-cene to 1.0 mole of acetic acid in place of the adduct synthesized from equivalent mole of 1,8-diazabicyclo[5,4,0]unde-7-cene and acetic acid.

### Example 9

Preparation of Holographic Recording Composition

A holographic recording composition was prepared in the same manner as Example 1 except that an adduct synthesized in a molar ratio of 100 moles of 1,8-diazabicyclo[5,4,0]unde-7-cene to 1.0 mole of acetic acid in place of the adduct synthesized from equivalent mole of 1,8-diazabicyclo[5,4,0]unde-7-cene and acetic acid.

### Example 10

Preparation of Holographic Recording Composition

A holographic recording composition was prepared in the same manner as Example 1 except that an adduct synthesized in a molar ratio of 1.0 mole of 1,8-diazabicyclo[5,4,0]unde-7-cene to 1.1 moles of acetic acid in place of the adduct synthesized from equivalent mole of 1,8-diazabicyclo[5,4,0]unde-7-cene and acetic acid.

### Comparative Example 1

Preparation of Holographic Recording Composition

31.5 g of biscyclohexyl methanediisocyanate, 61.2 g of polypropyleneoxide triol (molecular weight: 1000), 2.5 g of tetramethylene glycol, 3.1 g of 2,4,6-tribromophenylacrylate as a monomer, 0.69 g of a radical-photopolymerization initiator (Irgacure 784, by Ciba Specialty Chemicals Co.), and 1.01 g of dibutyltin dilaurate were stirred under nitrogen gas atmosphere to prepare a holographic recording composition.

### Comparative Example 2

Preparation of Holographic Recording Composition

0.35 g of acetic acid (by Tokyo Chemical Industry Co.), 31.5 g of biscyclohexyl methanediisocyanate (by Tokyo Chemical Industry Co.), 61.2 g of polypropyleneoxide triol (molecular weight: 1000), 2.5 g of tetramethylene glycol, 3.1 g of 2,4,6-tribromophenylacrylate, 0.69 g of a radical-photopolymerization initiator (Irgacure 784, by Ciba Specialty Chemicals Co.) and 1.01 g of dibutyltin dilaurate (by Wako Pure Chemical Industries, Ltd.) were stirred under nitrogen gas atmosphere to prepare a holographic recording composition.

### Examples 11 to 20 and Comparative Examples 3 to 4

Preparation of Optical Recording Media

One surface of a glass sheet of 0.5 mm thick was treated into antireflection of a reflectivity 0.1% with respect to a normal incident having a wavelength of 532 nm, to thereby prepare a first substrate.

Aluminum was vapor-deposited on one surface of another glass sheet of 0.5 mm thick to give a reflectivity of 90% with respect to a normal incident light of wavelength 532 nm, to thereby obtain a second substrate.

Then, a spacer of transparent polyethylene terephthalate sheet of 500 μm thick was disposed on the surface with no antireflection-treatment of the first substrate.

Then each of the holographic recording compositions obtained in Examples 1 to 10 and Comparative Examples 1 to 2 was mounted on the first substrate, then the side of the second substrate, where the aluminum being deposited, was contacted to the side of the composition of the hologram recording media on the first substrate so as to trap no air therebetween, thereby the first substrate and the second substrate were laminated along with the spacer interposed therebetween. Thereafter, they were allowed to stand at 45° C. for 24 hours to prepare the respective optical recording media of Examples 11 to 20 and Comparative Examples 3 to 4.

Recording and Evaluation

By means of Collinear hologram recording/reproducing examiner SHOT-1000 (by Pulsetec Industrial Co.), the resulting optical recording media of Examples 11 to 20 and Comparative Examples 3 to 4 were respectively subjected to writing a series of multiplex holograms with a recording spot diameter of 200 μm at the focal point of the hologram recording. The recorded holograms were measured and evaluated in terms of sensitivity i.e. recording energy and bit error rate (BER). The results are shown in Table 1.

Measurement of Sensitivity and Error Rate

The resulting optical recording media were measured for the variation of bit error rate (BER) in reproduction signals while varying the irradiation light energy (mJ/cm²) at the recording. As recording optical energy increases, the brightness (μON) of the reproduction signal typically increases and the BER of the reproduction signal tends to gradually decrease. In these experiments, the irradiating optical energy, at which the reproduction signal corresponding to μON=200, was determined as the recording sensitivity of the optical recording media, and also the error rate (BER) at its condition was measured.

TABLE 1

| Optical | Optical | | |
|---|---|---|---|
| Recording | Recording | Sensitivity | Error |
| Medium | Composition | (mJ/cm²) | (BER) |
| Ex. 11 | Ex. 1 | 6 | 1 × 10⁻⁵ |
| Ex. 12 | Ex. 2 | 14 | 1 × 10⁻⁵ |
| Ex. 13 | Ex. 3 | 40 | 1 × 10⁻⁵ |
| Ex. 14 | Ex. 4 | 9 | 1 × 10⁻⁵ |
| Ex. 15 | Ex. 5 | 7 | 1 × 10⁻⁵ |
| Ex. 16 | Ex. 6 | 6 | 1 × 10⁻⁵ |
| Ex. 17 | Ex. 7 | 8 | 1 × 10⁻⁵ |
| Ex. 18 | Ex. 8 | 7 | 1 × 10⁻⁵ |
| Ex. 19 | Ex. 9 | 7 | 1 × 10⁻⁵ |
| Ex. 20 | Ex. 10 | 50 | 1 × 10⁻⁵ |
| Com. Ex. 3 | Com. Ex. 1 | 80 | 1 × 10⁻⁵ |
| Com. Ex. 4 | Com. Ex. 2 | 120 | 1 × 10⁻³ |

The results of Table 1 demonstrate that the optical recording media of Examples 11 to 20, formed from the optical recording compositions of Examples 1 to 10, exhibit excellent recording sensitivities and lower error rates compared to the optical recording media of Comparative Examples 3 and 4 formed from the optical recording compositions of Comparative Examples 1 and 2.

The holographic recording compositions according to the present invention may lead to producing highly sensitive optical recording media, thus are appropriately utilized for various optical recording media of volume hologram type that can record images with higher density.

The optical recording media according to the present invention are highly sensitive, thus are also appropriately employed in various optical recording media of volume hologram type that can record images with higher density.

What is claimed is:

1. A holographic recording composition comprising:
an imine compound having a pKa of 11 or more in water at 25° C., and an acidic compound having a pKa of below 11 in water at 25° C.

2. The holographic recording composition according to claim 1, wherein the imine compound having a pKa of 11 or more in water at 25° C. is expressed by General Formula (1) below: 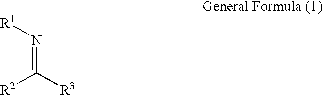
in the General Formula (1), R¹, R² and R³, which may be identical or different each other, each represents an alkyl group, an aryl group, an amino group or an acyl group; the alkyl group, the aryl group, the amino group or the acyl group may further have a substituent.

3. The holographic recording composition according to claim 1, wherein the mole ratio of the imine compound having a pKa of 11 or more in water at 25° C. to the acidic compound having a pKa of below 11 in water at 25° C. (mole number of imine compound/mole number of acidic compound) is 100/1 to 1/1.

4. The holographic recording composition according to claim 1, wherein at least a portion of the imine compound having a pKa of 11 or more in water at 25° C. and at least a portion of the acidic compound having a pKa of below 11 in water at 25° C. form a complex salt expressed by General Formula (2) below: 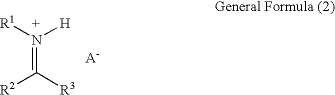
in the General Formula (2), R¹, R² and R³, which may be identical or different each other, each represents an alkyl group, an aryl group, an amino group or an acyl group; the alkyl group, the aryl group, the amino group or the acyl group may further have a substituent; the A⁻ indicates an anion species.

5. The holographic recording composition according to claim 2, wherein any two of R¹, R² and R³ bind each other to form at least one ring structure in the compound expressed by the General Formulas (1) and/or (2).

6. The holographic recording composition according to claim 5, wherein all of R¹, R² and R³ bind each other to form at least two ring structures in the compound expressed by the General Formulas (1) and/or (2).

7. The holographic recording composition according to claim 2, wherein at least one of R¹, R² and R³ contains a nitrogen atom in the compound expressed by the General Formulas (1) and/or (2).

8. The holographic recording composition according to claim 7, wherein at least one of R² and R³ is an amino group in the compound expressed by the General Formulas (1) and/or (2).

9. The holographic recording composition according to claim 8, wherein R¹ is an alkyl group, and at least one of R² and R³ is an amino group in the compound expressed by the General Formulas (1) and/or (2).

10. The holographic recording composition according to claim 4, wherein the anion species expressed by the A⁻ in the General Formula (2) is one of carboxylate anions and aryloxy anions.

11. The holographic recording composition according to claim 1, the imine compound having a pKa of 11 or more is at least one of 1,8-diazabicyclo[5,4,0]unde-7-cene, 1,5-diazabicyclo[4,3,0]non-5-ene and 7-methyl-1,5,7-triazabicyclo[4,4,0]de-5-ene.

12. The holographic recording composition according to claim 1, further comprising at least one of radical-polymerizable monomers and photopolymerization initiators.

13. The holographic recording composition according to claim 12, further comprising a urethane matrix that is formed from a polyfunctional isocyanate and a polyfunctional alcohol.

14. An optical recording medium, comprising a holographic recording layer,
wherein the holographic recording layer is formed from a holographic recording composition that comprises an imine compound having a pKa of 11 or more in water at 25° C. and an acidic compound having a pKa of below 11 in water at 25° C.

15. The optical recording medium according to claim 14, further comprising a first substrate, a filter layer and a second substrate in addition to the holographic recording layer.

16. The optical recording medium according to claim 15, wherein at least one of the first substrate and the second substrate comprises a servo pit pattern.

17. The optical recording medium according to claim 16, further comprising a reflective film on the surface of the servo pit pattern.

18. The optical recording medium according to claim 15, wherein the filter layer transmits a first light and reflects a second light.

19. The optical recording medium according to claim 15, further comprising a first gap layer, between the filter layer and the reflective film, for smoothening the surface of the first substrate.

20. The optical recording medium according to claim 15, further comprising a second gap layer between the holographic recording layer and the filter layer.
